(19) United States
(12) Patent Application Publication
(10) Pub. No.: US 2005/0199286 A1
(43) Pub. Date: Sep. 15, 2005

(54) Pressure protection system

(76) Inventors: David Eric Appleford, Essex (GB); Brian William Lane, Essex (GB); Ronald Geoffrey William Smith, Hertfordshire (GB); Nicholas John Abbott Andrews, Essex (GB)

Correspondence Address: SUMMA & ALLAN, P.A., 11610 NORTH COMMUNITY HOUSE ROAD, SUITE 200, CHARLOTTE, NC, 28277, US

(21) Appl. No.: 10/517,697

(22) PCT Filed: Jun. 10, 2003
(86) PCT No.: PCT/GB03/02485

§ 371 Date: Dec. 13, 2004

(30) Foreign Application Priority Data
Jun. 13, 2002 (GB) 0213635.6

(51) Int. Cl. F16K 17/00

(52) U.S. Cl. 137/487.5

(57) ABSTRACT

A pressure protection system (32) has a docking manifold (44) to which an upstream portion (36) and a downstream portion (38) of a pipeline (34) are connected. Also connected to the docking manifold (44) is a retrievable module (64) which has a conduit circuit (66) that connects the upstream and downstream portions of the pipeline (34) enabling fluid to flow between the two portions (36, 38). The conduit circuit contains two fail-safe valves (72) which are controlled by a control module (80) within the retrievable module, and two pressure transmitters (76) co-operable with the control module (80). When wither pressure transmitter (76) senses fluid pressure in the conduit circuit (66) to be above a threshold value then it causes the control module (80) to effect closure of the valves (72) preventing the pressure rise from reaching the downstream portion (38) of the pipeline (34).

The present invention relates to a system for protecting a downstream region of a pipeline and components connected thereto from high pressure which may occur in an upstream region thereof.

The system will be described in the context of a pipeline used for delivering hydrocarbon output from a sub-sea well to a host facility but would be equally applicable to any pipeline which is situated such that access thereto is difficult. The pipeline could also be used for conveying other fluids.

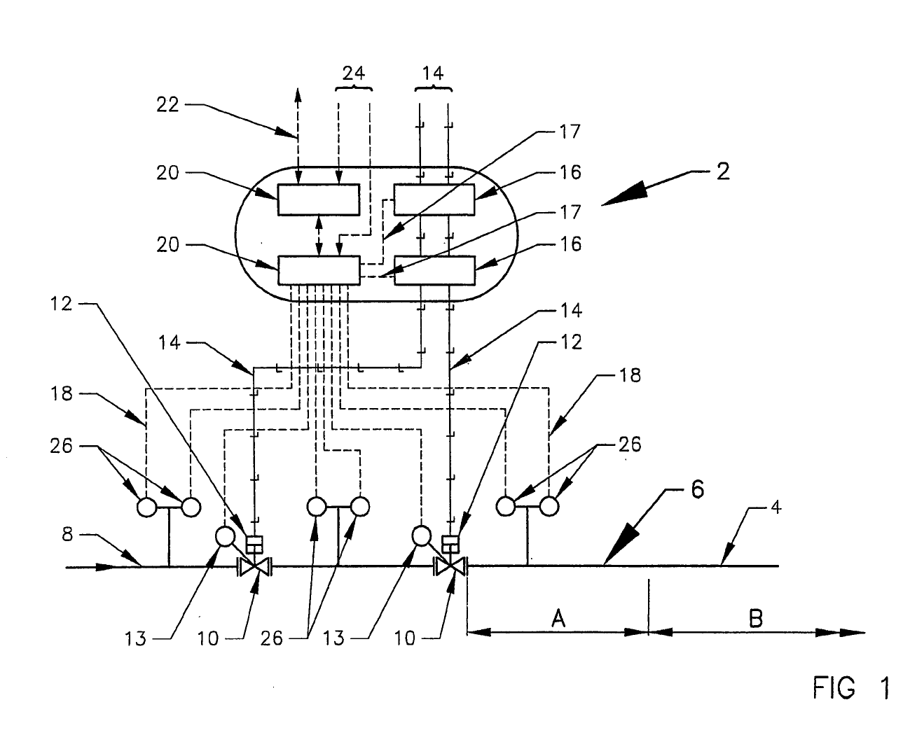

In the oil and gas industry, so-called high integrity pressure protection systems (HIPPS) are sometimes employed. Such systems may be installed close to a wellhead in a pipeline used to convey fluid, such as oil or gas, from the wellhead to a remote host location. If all equipment downstream of the wellhead needs to be able to withstand the maximum well pressure (resulting from shutting in of the well) the cost of the equipment, including the pipeline, will be undesirably high. In order to reduce the pressure that such equipment needs to be able to withstand, and consequently reduce its cost, a pressure protection system may be installed in the pipeline close to the wellhead. An example of such an existing system is shown in FIG. 1. Due to the high importance of the system functioning as required, all system components, control lines etc. are duplicated. The system 2 is arranged to protect a downstream region 4 of a pipeline 6 from overpressure which may occur via an upstream region 8 thereof leading from a wellhead. The system includes two fail-safe closed valves 10 (i.e. ones which close automatically in the absence of power being supplied thereto, usually in the form of pressured hydraulic fluid) which are openable by means of an actuators 12, normally supplied with pressurised hydraulic fluid via a power supply line 14 and regulated by a control valve 16 and control signal line 17. The state of each valve is detected by a position sensor 13. Pressure is monitored immediately up- and downstream of the failsafe valves 10 by means of pressure transmitters 26 which sense pressure and transmit pressure signals and are connected via electrical signal lines 18 to a safety controller unit 20 which is in turn connected to the host facility by a surface communication line 22 and dual electrical power supply lines 24. When the pressure transmitters 26 detect a pressure higher than a predetermined threshold pressure, an appropriate signal is transmitted to the host facility and the supply of pressurised hydraulic fluid to the power supply lines 14 is cut off which results in the actuators 12 automatically allowing the failsafe valves 10 to close. The existence of the system 2 permits pipeline components etc. in the region marked B and downstream thereof to be derated or designed to cope with a lower maximum pressure than would be possible without the system. The pipeline region marked A is a so-called fortified zone and is designed to accommodate a higher pressure than region B to take account of the time delay between sensing of the threshold pressure and closing of the failsafe valves 10.

The above system suffers from a number of drawbacks. Firstly, if any components need repair or maintenance, they have to be retrieved individually which is a hazardous and time-consuming task if the system is installed on the seabed. As a consequence of this drawback, system components need to be specified to last for the full life of the field in which they are installed. Secondly, the system cannot be tested prior to installation and thirdly, in the latter stages of the life of a field, the well pressure may drop to such an extent that such a system is no longer necessary. Since the system would be costly to remove, it is left in situ and there is a danger that the system may malfunction and close the failsafe valves 10 thereby interrupting the flow from the wellhead which has serious financial implications. For these reasons it is believed that only two such systems have ever been installed in a submarine environment.

The consequence of not employing such a system is that it is not possible to install derated pipes, equipment etc. downstream of the wellhead. This has undesirable cost implications particularly for the pipeline itself. A derated pipeline can generally be laid relatively quickly from a reel-lay barge in which the thinner walled derated pipeline can be stored on a reel for laying purposes. Relatively thicker walled pipeline sections capable of withstanding initial well shut-in pressure are normally too rigid to be dispensed from a reel laying vessel. Welding adjacent pipe lengths together and then encasing the joint in concrete undesirably prolongs the pipe laying process.

The object of the invention is to overcome at least some of the above-mentioned problems.

Thus, according to the invention there is provided a pressure protection system for sensing a pressure of a fluid flowing in a pipeline and isolating a downstream portion of the pipeline from an upstream portion thereof in response to the pressure of the fluid reaching a threshold value, the system comprising a first valve connectable to the pipeline such that the fluid flows therethrough when flowing from the upstream portion of the pipeline to the downstream portion thereof, control means for controlling the first valve and pressure sensing means co-operable with the control means upon sensing fluid pressure in the pipeline at or above the threshold value to cause the control means to effect closure of the first valve, wherein the first valve, the control means and the pressure sensing means form part of a retrievable module.

Such an arrangement permits the assembled system to be tested prior to installation and can be easily retrieved for maintenance, repair, replacement etc. Accordingly, the system need not be designed to last for the entire life of the application in which it is used. Furthermore, removal of the module permits the pressure protection system to be easily removed when it is no longer required (possibly in the latter stages of production from a hydrocarbon reservoir). This avoids the danger of false actuation of such a system shutting in production from the hydrocarbon reservoir and means that an alternative module may be used in its place to carry out alternative functions such as separating constituent components of fluid issuing from the reservoir in order that they can be conveyed to a host facility more efficiently. Furthermore by the use of such a system a high pressure field can be linked to an existing facility having a lower pressure rating or a floating production storage and offloading facility which uses flexible riser pipes which may not be capable of withstanding the well shut-in pressure from the high pressure field.

By making the use of a pressure protection system more cost effective also widens the situations in which it is viable to use which in turn enables cheaper derated components, pipelines etc. to be employed downstream of the system. As mentioned above, the use of derated pipelines not only makes the pipe cheaper but also enables the pipes to be laid much more efficiently from a reel-lay barge.

Preferably, the module includes an inlet port, an outlet port and a conduit circuit connecting the ports and including the first valve which is closable to prevent flow around the conduit circuit.

In order to facilitate installation and retrieval of the module and connection with and disconnection from the pipeline, the system preferably further comprises a docking manifold adapted to be installed in the pipeline between the upstream and downstream portions thereof, and including manifold conduits for routing the fluid flowing therethrough to and from the inlet and outlet ports of the module when it is docked with the docking manifold.

So as to minimise the number of connections which have to be established and separated during installation and retrieval of the module, preferably the manifold conduits terminate in a first part of a connector forming part of the docking manifold and the inlet and outlet ports of the module are included in a second part of the connector engageable with the first part thereof.

Preferably, the module also includes a second valve which is closable by the control means to prevent flow around the conduit circuit so that failure of one valve in the module will not reduce its effectiveness. The or each valve is preferably a fail-safe closed valve which closes in the absence of power.

In order to avoid the necessity of providing hydraulic power supply lines from the host facility to the system for closing and/or opening the valves, preferably the control means of the or each valve includes an electric motor for closing and/or opening the valve. More preferably, the electric motor is arranged to open the valve and a spring is arranged to close the valve in the absence of electrical power.

Preferably, the system includes first and second said modules in order that one module may be retrieved for maintenance, repair and/or replacement without needing to shut off flow through the pipeline or leave components downstream of the system unprotected.

In order to facilitate switching the flow through the pipeline from one module to the other, preferably the docking manifold is adapted to be docked by both of the modules and the manifold conduits are adapted to selectively route the fluid flowing through the docking manifold through either the conduit circuit of the first or the second module.

More preferably, the docking manifold is adapted to receive first and second flows flowing between upstream and downstream portions of first and second pipelines respectively. With such a system, flows through the two pipelines (e.g. a production pipeline and a test pipeline) can both be controlled. Preferably, the manifold conduits are adapted to route flows in each of the first and second pipelines through the first or second module. With such an arrangement, it will be possible to provide protection against over-pressurisation of downstream regions of two pipelines with only two modules. The system can however be arranged to permit routing of flows from upstream regions of both of the pipelines through one of the modules and then to a downstream region of one of the pipelines to permit the other module to be removed from the system for maintenance, repair and/or replacement.

The invention also provides a method of operating the system referred to above including the steps of:
(i) routing fluid from the upstream portion to the downstream portion of the pipeline through the module;
(ii) isolating the system from fluid flowing through the pipeline;
(iii) retrieving the module;
(iv) replacing the module with the same module after it has been overhauled or with a replacement module; and
(v) re-establishing the flow of fluid through the module.

When the system includes two modules, the method may alternatively include the steps of:
(i) routing fluid from the upstream portion of the pipeline through the first module then via the manifold conduits to the downstream portion of the pipeline;
(ii) switching the flow so that it flows through the second instead of the first module;
(iii) closing valves to isolate the first module from flows in the manifold conduits;
(iv) retrieving the first module;
(v) replacing the first module with the same module after it has been overhauled or with a replaced module; and
(vi) re-establishing a flow through the overhauled or replacement module.

The invention will now be described by way of example only with reference to the accompanying schematic drawings in which:

FIG. 1 shows a prior art pressure protection system;

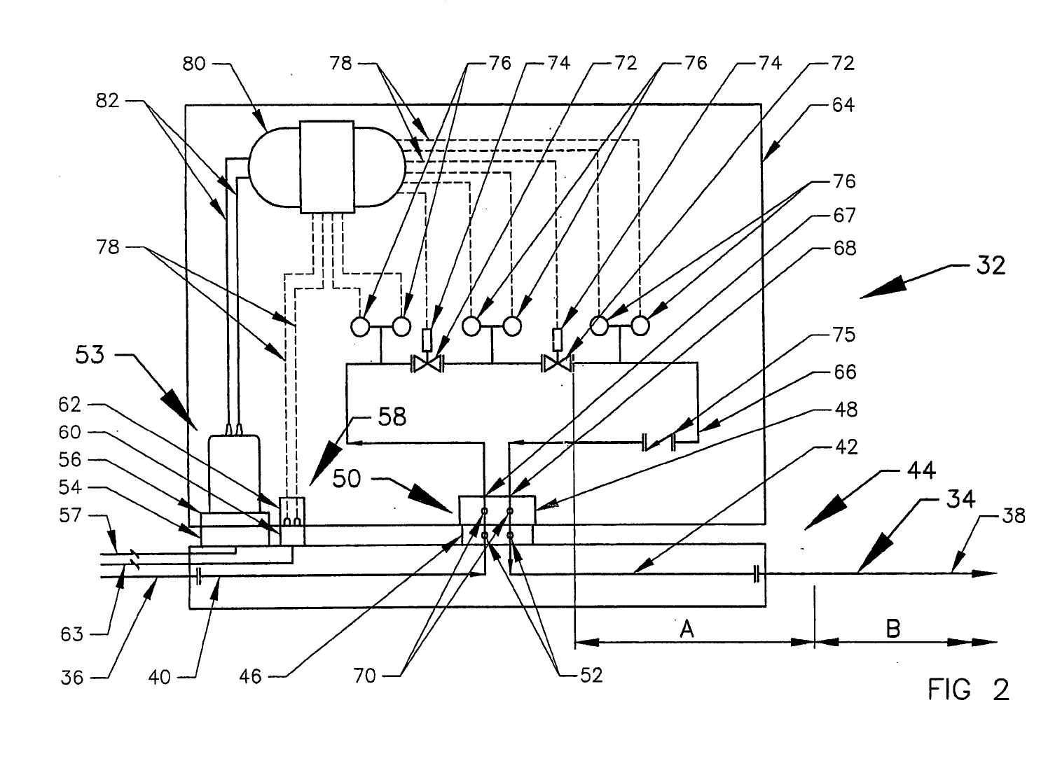

FIG. 2 shows a first embodiment of a pressure protection system according to the invention;

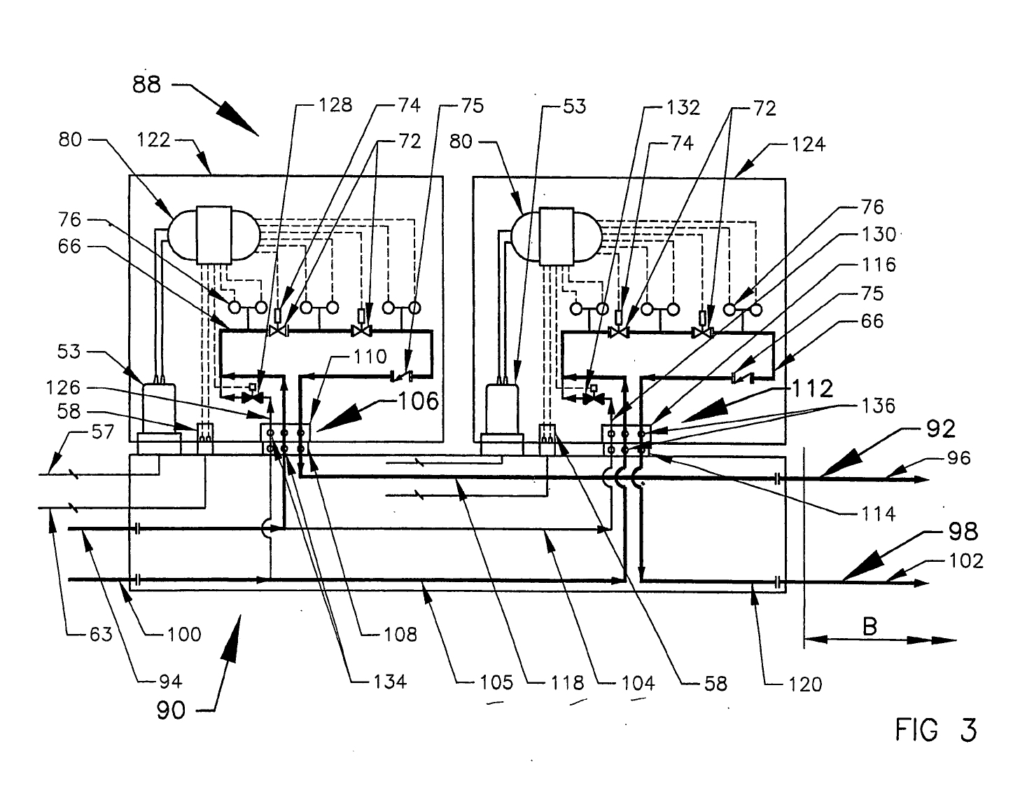

FIG. 3 shows a second embodiment of a pressure protection system according to the invention in a first configuration;

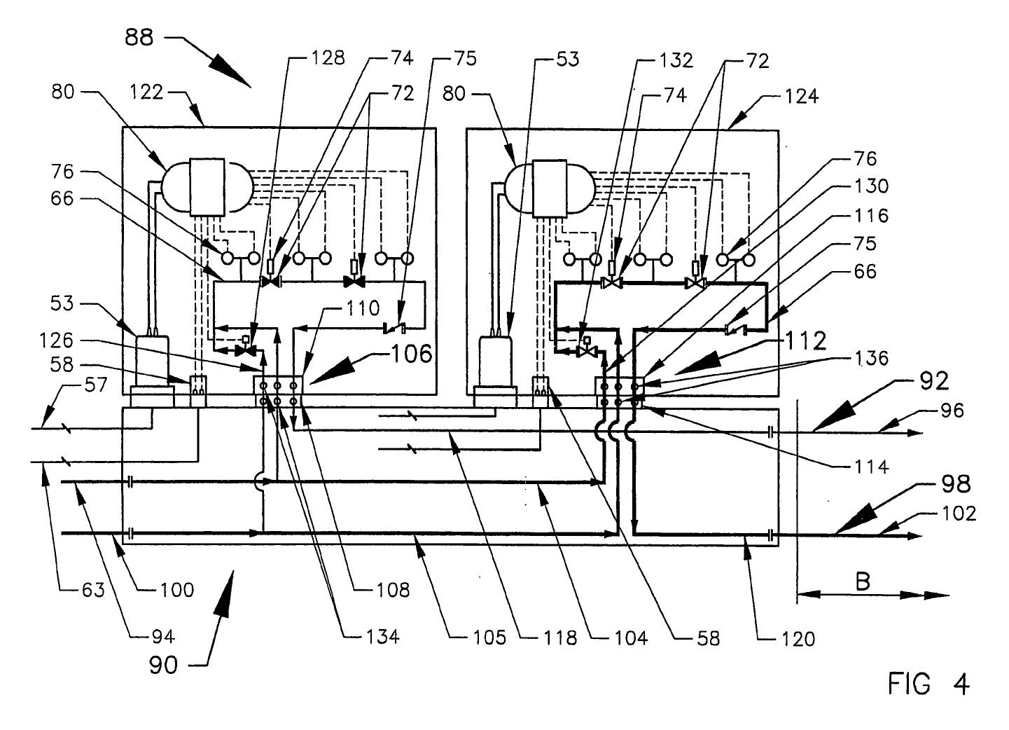

FIG. 4 shows the second embodiment in a second configuration; and

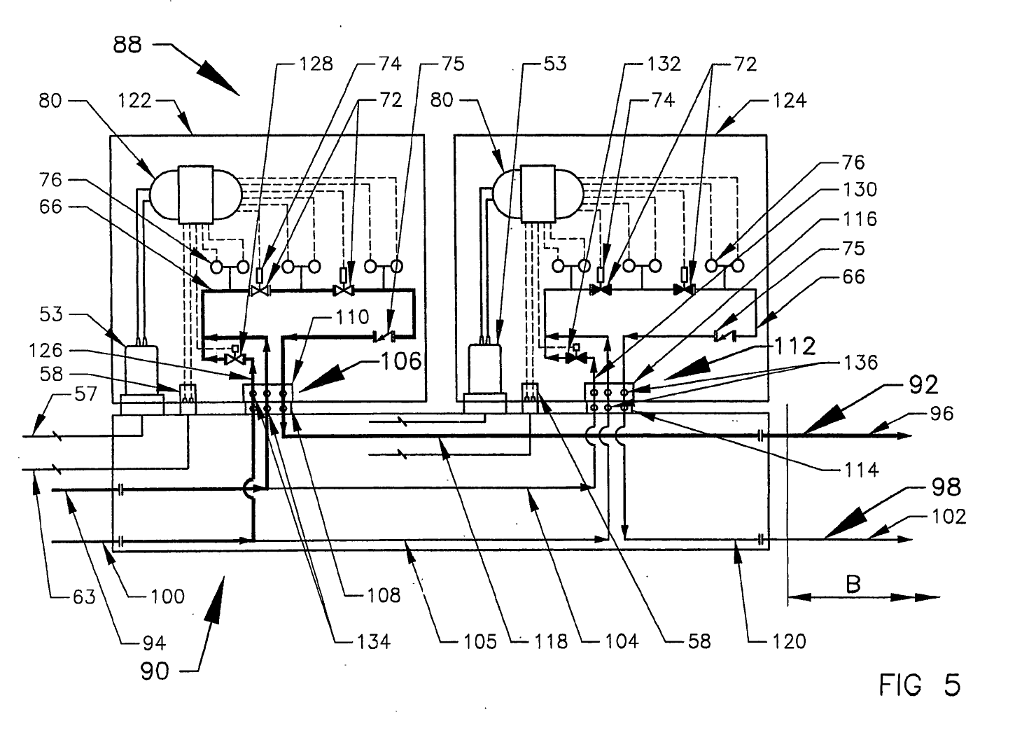

FIG. 5 shows the second embodiment in a third configuration.

FIG. 2 shows a first pressure protection system 32 according to the invention. A pipeline 34 comprises an upstream portion 36 leading from a wellhead (not shown) and a downstream portion 38 leading to a remote host facility (not shown). The upstream and downstream portions 36 and 38 of the pipeline are respectively connected to inlet and outlet manifold conduits 40 and 42 in a docking manifold 44. These conduits terminate in a first part 46 of a conduit connector 50 which includes isolation valves 52 for cutting off flow through the manifold conduits 40 and 42.

The docking manifold 44 also includes first parts 54 and 60 of a power connector 53 and a control connector 58 which are respectively connected via a power line 57 and a signal line 63 directly or indirectly to the host facility.

The system also includes a removable module 64 which is engageable with the docking manifold 44. The module 64 includes a conduit circuit 66 comprising a piping loop connecting an inlet port 67 and an outlet port 68 of a second part 48 of the conduit connector 50 which includes isolation valves 70 for closing off the inlet and outlet ports. The conduit circuit 66 contains two fail-safe closed valves 72, each of which is spring-biased closed and openable by an actuator 74 in the form of an electric motor. The conduit circuit also includes an optional non-return valve 75. Duplicated pressure-sensing and transmitting devices or pressure transmitters 76 are arranged to sense fluid pressure in the conduit circuit 66 and transmit signals via electrical signal lines 78 (shown dotted) to a power and control module 80 which is connected by further electrical signal lines 78 to a second part 62 of the control connector 58 and by electrical power cables 82 to a second part 56 of the power connector 53. When the module 64 engages the docking manifold 44 the first parts 46, 54 and 60 of the three connectors 50, 53 and 58 matingly engage the complementary second connector parts 48, 56 and 62 respectively.

All system components in a so-called fortified zone A, extending a certain distance downstream of the failsafe valves 72, are designed to withstand a higher pressure than components further downstream in a so-called derated zone B. This is because the slight delay in closing the failsafe valves 72 may result in a certain amount of a pressure surge reaching the components in the fortified zone A. Components in the derated zone B can however have a reduced pressure rating since they will be completely protected from such pressure surges.

The system shown in FIG. 2 operates in the following way. With the module 64 engaged with the docking manifold 44, as shown in FIG. 2, fluid flowing from the upstream portion 36 of the pipeline 34 enters the inlet manifold conduit 40 and passes through the open valves 52 and 70 of the conduit connector 50 into the conduit circuit 66. The fluid then passes around the conduit circuit 66, the failsafe valves 72 which are held in an open state by electrical power supply to the actuators 74 by the power and control module 80 and out of the module 64 into the outlet manifold conduit 42 via the open valves 52 and 70 of the conduit connector 50. The fluid then passes out of the docking manifold 44 into the downstream portion 38 of the pipeline for conveyance to the host facility.

The pressure upstream and downstream of the failsafe valves 72 is monitored by the power and control module 80 on the basis of signals from the pressure transmitters 76 and if for any reason the pressure of the fluid entering the module rises above a threshold level then this is detected from signals from one or more of the pressure transmitters. The power and control module 80 then interrupts the supply of electrical power to the two actuators 74. Springs in the actuators then rapidly close the failsafe valves 72 thus preventing the pressure rise from reaching the down stream portion 38 of the pipeline.

Should it be necessary to retrieve the module for repair or maintenance or so that it can be replaced by an alternatively configured module (e.g. for separating constituent components of fluid flowing through the pipeline) the isolation valves 52 and 70 in the conduit connector 50 are closed the module 64 is separated from the docking manifold 44 and returned to a servicing facility for overhaul. This module is replaced with an alternative module which has been fully tested at the servicing facility prior to installation.

A second system 88 according to the invention will now be described with reference to the FIGS. 3, 4 and 5. Elements of the second system which correspond to those of the first system are designated with like numerals and not described in detail again.

The system is used to prevent overpressurisation of downstream portions 96 and 102 of a production pipeline 92 and a test pipeline 98, upstream portions 94 and 100 of which are connected to an inlet production conduit 104 and an inlet test conduit 105 of a docking manifold 90. Each of the inlet conduits 104 and 105 are connected to manifold parts 108 and 114 of conduit connectors 106 and 112 which are arranged for engagement by complementary module parts 110 and 116 of the connectors 106 and 112. The manifold part 108 of the first connector 106 has an outlet connected to an outlet production conduit 118 of the docking manifold 90. The manifold part 114 of the second connector 112 has an outlet connected to an outlet test conduit 120. The outlet production and test conduits 118 and 120 are respectively connected to downstream portions 96 and 102 of the production and test pipelines 92 and 98.

The system includes first and second modules 122 and 124 which normally respectively control pressure in downstream portions 96 and 102 of the production and test pipelines 92 and 98. The first module 122 includes the module part 110 of the first connector 106. The first connector 106 places a conduit circuit 66 of the first module 122 in communication with the inlet and outlet production conduits 104 and 118. Conduit circuit 66 is also connected by a test bypass 126 containing a normally closed flow diverter valve 128 to the inlet test conduit 105 via the first connector 106.

In a similar manner, the second module 124 includes the module part 116 of the second connector 112. The second connector 112 places a conduit circuit 66 of the second module 124 in communication with the inlet and outlet test conduits 105 and 120. The conduit circuit 66 is also connected by a production by-pass 130 containing a normally closed flow diverter valve 132 to the inlet production conduit 104 via the second connector 112.

The by-pass flow diverter valve 128 or 132 in each module is controlled by the associated power and control module 80.

Each part of each conduit connector 106 and 112 includes three isolation valves 134, 136 for closing off the three conduits connected thereto.

The operation of the second system 88 will now be described with reference to FIGS. 3, 4 and 5 in which fluid conduits and pipelines shown with thick lines designate ones through which fluid is flowing and fluid conduits and pipelines shown with thin lines designate ones through which fluid is not normally flowing.

Under normal operating conditions (FIG. 3), downstream portions 96 and 102 of the production and test pipelines 92 and 98 will be protected from overpressurisation by the first and second modules 122 and 124 respectively in the manner described above with reference to the first system 32. In this state the by-pass flow diverter valves 128 and 132 will both be closed and all of the isolation valves 134 and 136 will be open.

If there is a requirement to retrieve the first module 122 for inspection, repair, maintenance, etc., the flow diverter valve 132 of the second module 124 will be opened by means of an appropriate signal from the power and control module 80 of the second module 124 as shown in FIG. 4. This will allow production fluid from the inlet production conduit 104 to enter the second module 124 via the production by-pass 130 and pass, together with test fluid, around the conduit circuit 66 of the second module 124 then through the outlet test conduit 120 and into the downstream portion 102 of the test pipeline 98.

The isolation valves 134 of the first connector 106 can then be closed and the first module 122 retrieved for maintenance, repair etc. Once a replacement module has been docked with the docking manifold 90 in place of the first module 122, normal flow can be resumed as shown in FIG. 3.

Likewise, if there is a requirement to retrieve the second module 124 the flow diverter valve 128 of the first module 122 will be opened as shown in FIG. 5. This will allow test fluid from the inlet test conduit 105 to enter the first module 122 via the test by-pass 126 and pass, together with production fluid, around the conduit circuit 66 of the first module 122 then through the outlet production conduit 118 and into the down stream portion 96 of the production pipeline 92. The isolation valves 136 of the second connector 112 can then be closed and the second module 124 retrieved for maintenance, repair etc. Once the replacement module has been docked with the docking manifold 90 in place of the second module 124, normal flow can be resumed as shown in FIG. 3.

As with the first system 32, when the pressure of the reservoir supplying fluid to the system 88 has fallen sufficiently so that a HIPPS is no longer required, the modules 122 and 124 could be replaced with simple flow through modules or modules configured with processing equipment which would benefit production from the reservoir, such as equipment to separate constituent components of the fluid. The pipework configuration in the docking manifold would permit two separation modules to operate in parallel with each other and deliver two different separated fluids, for example oil and gas, for conveyance to the host facility via the pipelines 92 and 98. Alternatively, modules configured with multi-phase pumps can be used to boost production through the production and test pipelines.

1. A pressure protection system for sensing a pressure of a fluid flowing in a pipeline and isolating a downstream portion of the pipeline from an upstream portion thereof in response to the pressure of the fluid reaching a threshold value, the system comprising
a first valve connectable to the pipeline such that the fluid flows therethrough when flowing from the upstream portion of the pipeline to the downstream portion thereof;
control means for controlling the first valve; and
pressure sensing means co-operable with the control means;
wherein upon sensing fluid pressure in the pipeline at or above the threshold value the pressure sensing means causes the control means to effect closure of the first valve; and
wherein the first valve, the control means and the pressure sensing means form part of a retrievable module.

2. The system as claimed in claim 1, wherein the module includes an inlet port, an outlet port and a conduit circuit connecting the ports and including the first valve which is closable to prevent flow around the conduit circuit.

3. The system as claimed in claim 2, including a docking manifold adapted to be installed in the pipeline between the upstream and downstream portions thereof, and including manifold conduits for routing the fluid flowing therethrough to and from the inlet and outlet ports of the module when it is docked with the docking manifold.

4. The system as claimed in claim 3, wherein the manifold conduits terminate in a first part of a connector forming part of the docking manifold and the inlet and outlet ports of the module are included in a second part of the connector engageable with the first part thereof.

5. The system as claimed in claim 2, wherein the module includes a second valve which is closable by the control means to prevent flow around the conduit circuit.

6. The system as claimed in claim 1, wherein said first valve comprises a fail-safe closed valve which closes in the absence of power.

7. The system as claimed in claim 1, wherein the control means of said first valve includes an electric motor for closing and/or opening the valve.

8. The system as claimed in claim 7, wherein the electric motor is arranged to open said first valve and a spring is arranged to close said first valve in the absence of electrical power.

9. The system as claimed in claim 1, including first and second modules.

10. The system as claimed in claim 9, wherein the docking manifold is adapted to be docked by both of the modules and the manifold conduits are adapted to selectively route the fluid flowing through the docking manifold through either the conduit circuit of the first or the second module.

11. The system as claimed in claimed 10, wherein the docking manifold is adapted to receive first and second flows flowing between upstream and downstream portions of first and second pipelines respectively.

12. The system as claimed in claim 11, wherein the manifold conduits are adapted to route flows in each of the first and second pipelines through the first or second module.

13. The system as claimed in claim 11, wherein the manifold conduits are adapted to permit routing of flows from upstream portions of both of the pipelines through one of the modules and then to a downstream portion of one of the pipelines to permit the other module to be removed from the system.

14. The system as claimed in claim 9, wherein each said module includes a flow diverter valve for diverting flow towards the other said module to said module.

15. The system as claimed in claimed 14, wherein each module is adapted to receive flow from one of the pipelines and is connected by a bypass to the other pipeline, each said bypass including one of said flow diverter valves.

16. A method of operating the system as claimed in claim 1, including the steps of:
(i) routing fluid from the upstream portion to the downstream portion of the pipeline through the module;
(ii) isolating the system from fluid flowing through the pipeline;
(iii) retrieving the module;
(iv) replacing the module with the same module after it has been overhauled or with a replacement module; and
(v) re-establishing the flow of fluid through the module.

17. A method of operating the system as claimed in claim 9, including the steps of:
(i) routing fluid from the upstream portion of the pipeline through the first module then via a said manifold conduit to the downstream portion of the pipeline;
(ii) switching the flow so that it flows through the second instead of the first module;
(iii) closing valves to isolate the first module from flows in the manifold conduits;
(iv) retrieving the first module);
(v) replacing the first module with the same module after it has been overhauled or with a replacement module; and
(vi) re-establishing a flow through the overhauled or replacement module.
